(19) United States
(12) Patent Application Publication
(10) Pub. No.: US 2004/0218198 A1
(43) Pub. Date: Nov. 4, 2004

(54) Image record processing method, and heat development recording apparatus

(75) Inventor: Yoshiko Ozaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/834,019

(22) Filed: Apr. 29, 2004

(30) Foreign Application Priority Data
May 2, 2003 (JP) P. 2003-127262

(51) Int. Cl. G06F 15/00; G03C 11/12

(52) U.S. Cl. 358/1.8; 358/1.7

(57) ABSTRACT

An image record processing method comprises: (1) generating a plurality of record jobs corresponding to a plurality of image information data transmitted from at least one of an image information source; (2) performing record processing to achieve heat development; the processing including: (2-1) performing one of the record jobs with a heat development recording apparatus, to thus form a latent image through exposure of a heat development recording material; and (2-2) heating the heat development recording material having the latent image formed thereon, and (3) sequentially performing the record processing with respect to each of the remaining record jobs, wherein, when the heat development recording apparatus receives a predetermined operation instruction from an operation input section while the record processing is being performed, at least a part of the processing of the operation instruction is performed simultaneously with at least a part of the record processing.

### BACKGROUND OF THE INVENTION

1. Field of the Invention

The present invention relates to a heat development recording apparatus and an image record processing method, wherein a heat development recording material, which is formed from a heat development photosensitive material or photosensitive/heat-sensitive recording material, is subjected to exposure recording and heat development.

2. Description of the Related Art

A wet system—which captures or records an image on a photosensitive material of silver-salt photography type and subjects the material to wet processing, to thus produce a reproduced image—has hitherto been used as an image recorder for recording an image for medical purposes, such as a digital radiography system, a CT, or an MR. In contrast, attention has recently been paid to a recorder of dry system (a heat development recording apparatus) which employs a heat development photosensitive material and does not involve wet processing. The heat development recording apparatus of this type performs all operations; that is, recording of a latent image on the surface of a recording material, development and fixing of the latent image, and transfer of the thus-fixed image, in a dry status. More specifically, a laser light beam modulated by a laser modulation section in accordance with image information is radiated onto a heat development photosensitive material formed from recording material (through scanning) by means of an exposure section, to thus form a latent image, and the thus-exposed heat development photosensitive material is then brought into contact with heating means by means of a heat development section, to thus perform heat development processing and produce an image (see, e.g., JP-A-2000-98576)

A related-art, medical heat development recording apparatus (dry imager) is connected directly to an image information source, such as a CT or an MR, by means of a communications cable. For instance, one heat development recording apparatus cannot be simultaneously connected with five to ten or more image information sources (in the case of direct connection of the heat development recording apparatus to the image information sources, a maximum of three inputs or thereabouts is common). Jobs to be recorded do not remain in large amount in the recorder. Further, when an increase in the number of image information sources to be connected directly is desired, an image server having a print server function is connected to the recorder, thereby operating a plurality of record jobs A, B, C, D, E, F, . . . , which are accumulated in the recorder and shown in FIG. 13.

However, as shown in FIG. 14, this case takes the following processing pattern. Namely, when an operation for processing, e.g., a record job Q of later sequence, with high priority has been performed before the record job C, there is performed an operation for changing recording priorities while record processing is temporarily stopped at a timing at which processing of the record job B has been completed. Subsequently, recording of the record job Q is started. In short, operation input becomes inoperable while the record processing is performed continuously, thereby inhibiting performance of an operation for changing priorities.

Adoption of network connection as a standard in accordance with the tendency toward an open system, in combination with improvement in progressing performance of the heat development recording apparatus, has led to an increase in the number of system configurations to which one heat development recording apparatus is connected, to, e.g., five or more image information sources. Under such a circumstance, in an increasing number of cases, tens of record jobs are accumulated in the heat development recording apparatus at the same time. For this reason, for instance, there has arisen a desire to perform an operation for assigning the highest priority to an output of a record job of an emergency case or a desire to readily cancel an output request through use of a heat development recording apparatus serving as a final output device. In contrast, the related-art heat development recording apparatus itself does not effect any operation or function for requesting record processing on a highest-priority basis, and a desire to enable ascertainment of conditions of stored record jobs and a flexible change in record has been expected.

### SUMMARY OF THE INVENTION

The present invention has been conceived in view of the foregoing conditions and aims at providing an image recording method and a heat development recording apparatus, wherein processing such as display and alteration of stored record jobs, are received while record processing is being continually performed, to thus perform the processing.

According to a first aspect of the invention, there is provided an image record processing method comprising: (1) generating a plurality of record jobs corresponding to a plurality of image information data transmitted from at least one of an image information source; (2) performing record processing to achieve heat development; the processing including: (2-1) performing one of the record jobs with a heat development recording apparatus, to thus form a latent image through exposure of a heat development recording material; and (2-2) heating the heat development recording material having the latent image formed thereon, and (3) sequentially performing the record processing with respect to each of the remaining record jobs, wherein, when the heat development recording apparatus receives a predetermined operation instruction from an operation input section while the record processing is being performed, at least a part of the processing of the operation instruction is performed simultaneously with at least a part of the record processing.

According to the image record processing method, when the operation instruction from the operation input section is accepted, processing pertaining to the operation instruction can be performed simultaneously with record processing even when the record processing is in progress. As a result, an operation instruction can be input from the operation input section at an arbitrary timing without an operator being aware of whether or not the record processing is in progress.

According to a second aspect of the invention, there is provided the image record processing method further comprising: displaying a queue list image of the record jobs on a display section of the heat development recording apparatus when the heat development recording apparatus receives a predetermined operation instruction from the operation input section.

According to the image record processing method, the record jobs which have arisen as a result of receipt of the operation instruction from the operation input section are displayed in the form of a queue list image. Hence, the heat development recording apparatus can ascertain whether or not a certain record job is in progress or how may record jobs are left before record processing is started. As a result, the status of a backlog of accumulated jobs can be ascertained by the heat development recording apparatus while record processing is carried out.

According to a third aspect of the invention, there is provided the image record processing method further comprising: selecting a specific record job as an object job to be processed when the heat development recording apparatus receives a predetermined operation instruction from the operation input section; and performing the object job with higher priority over other record jobs to effect recording, according to a predetermined operation instruction from the operation input section, if the selected job is in an unprocessed status.

According to the image record processing method, a specific record job can be recorded with higher priority as compared with other record jobs. Hence, even if a record job desired to be recorded urgently has arisen after other jobs, the execution priority of the record job desired to be recorded is changed, so that the job can be recorded earlier than the other record jobs.

According to a fourth aspect of the invention, there is provided the image record processing method further comprising: selecting a specific record job as an object job to be processed when the heat development recording apparatus receives a predetermined operation instruction from the operation input section; and deleting the object job according to a predetermined operation instruction from the operation input section, if the selected job is in an unprocessed status.

According to the image record processing method, when a specific record job has been selected as an object to be processed from the queue list image displayed on the display section and when the job to be processed is a backlog job, the job can be deleted. As a result, a record job whose output has become unnecessary can be readily deleted.

According to a fifth aspect of the invention, there is provided the image record processing method further comprising: selecting a specific record job as an object job to be processed when the heat development recording apparatus receives a predetermined operation instruction from the operation input section; and displaying detailed information about the object job, according to a predetermined operation instruction from the operation input section.

According to the image record processing method, when a specific record job has been selected as an object to be processed from the queue list image displayed on the display section and when the job to be processed is a backlog job, detailed information about the job (e.g., an AE title, an alias, an entry time, an identifier (i.e., an IP address), a status, a file size, and the number of copies) can be displayed. As a result, upon setting of presence or absence of record processing, the sequence of record processing, or the like, details of the job to be processed can be ascertained before recording, thereby eliminating wasteful record processing.

According to a sixth aspect of the invention, there is provided the image record processing method further comprising: refreshing the queue list image to the latest image of record jobs at a predetermined timing.

According to the image record processing method, the record jobs are refreshed at predetermined timing. As a result, an accurate list of record jobs can be ascertained.

According to a seventh aspect of the invention, there is provided the image record processing method, wherein the queue list image is automatically refreshed at every predetermined period.

According to the image record processing method, the queue list image is automatically refreshed at every period of time. As a result, the operator can be prevented from refresh with awareness, and hence an accurate list of record jobs can be ascertained at all times.

According to an eight aspect of the invention, there is provided the image record processing method, wherein the queue list image is automatically refreshed at every period instructed by operation performed by the operation input section.

According to the image record processing method, the queue list image can be refreshed at an arbitrary period of time, and hence an optimum refresh period can be set according to the frequency of processing of the record jobs.

According to a ninth aspect of the invention, there is provided a heat development recording apparatus used in a heat development record operation for (1) performing record processing to achieve heat development, the processing including: (1-1) performing one of a plurality of record jobs through use of the recorder, the record jobs being generated in accordance with a plurality of image information data transmitted from at least one of an image information source, to thus form a latent image through exposure of a heat development recording material; and (1-2) heating the heat development recording material having the latent image formed thereon, and (2) sequentially performing the record processing with respect to each of the remaining record jobs, the recorder comprising: a display section for displaying the status of at least one of the record jobs; an operation input section where an operation instruction pertaining to each of the record jobs is input; and a control section for controlling the heat development record processing, wherein, when the heat development recorder receives a predetermined operation instruction from the operation input section while the record processing is being performed, at least a part of the processing of the operation instruction is performed simultaneously with at least a part of the record processing.

According to the heat development recording apparatus, when the operation instruction entered by way of the operation input section is accepted, processing pertaining to the operation instruction can be performed simultaneously with record processing even when the record processing is in progress. As a result, an operation instruction can be input from the operation input section at an arbitrary timing without the operator being aware of whether or not the record processing is in progress.

### BRIEF DESCRIPTION OF THE DRAWINGS

FIG. 1 is a block diagram for describing a schematic structure of a heat development recording apparatus of the invention;

FIG. 2 is a block diagram showing a control system of the heat development recording apparatus;

FIG. 3 is a block diagram of a system to which the heat development recording apparatus is connected;

FIG. 4 is a flowchart describing details of a display on a display section and procedures for carrying out operation;

FIG. 5 is a descriptive view of an image to be displayed on the display section during printing operation;

FIG. 6 is a descriptive view of a queue list image displayed on the display section;

FIG. 7 is a descriptive view of a jobless image to be displayed on the display section;

FIG. 8 is a flowchart describing detailed procedures for carrying out operation;

FIG. 9 is a descriptive view showing detailed information to be displayed on the display section;

FIG. 10 is a descriptive view showing a deletion ascertainment image to be displayed on the display section;

FIG. 11 is a descriptive view of an image which awaits processing and is to be displayed on the display section;

FIG. 12 is a descriptive view showing a task schedule of the heat development recording apparatus of the present invention;

FIG. 13 is a descriptive view showing a task list of a related-art device; and

FIG. 14 is a descriptive view showing a task schedule of the related-art device.

### DETAILED DESCRIPTION OF THE INVENTION

A preferred embodiment of an image processing method and a heat development recording apparatus of the invention will be described in detail hereinbelow by reference to the drawings.

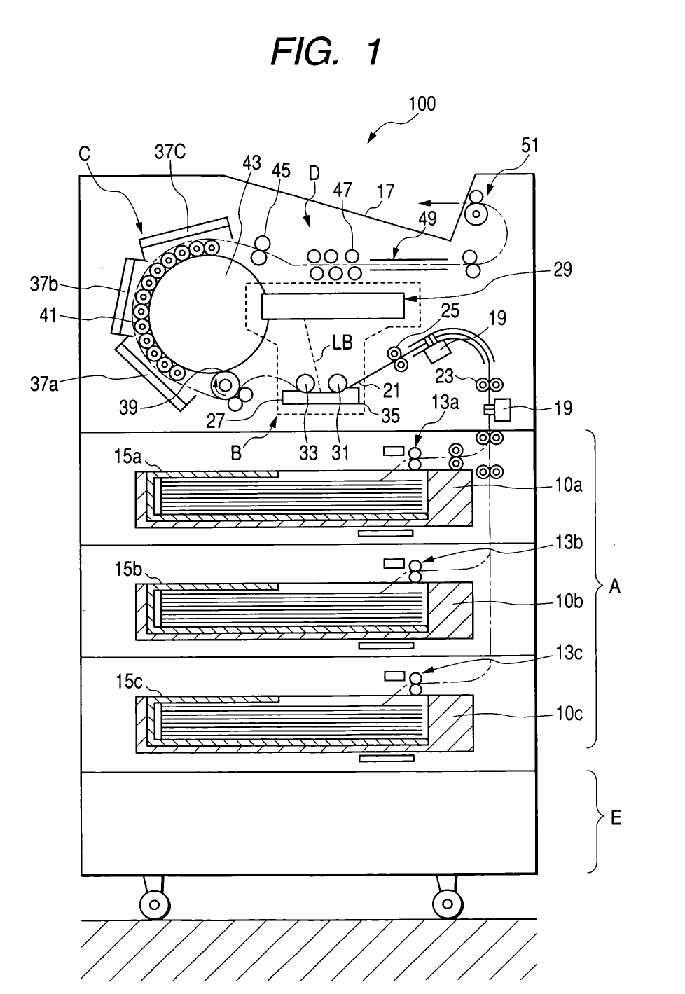

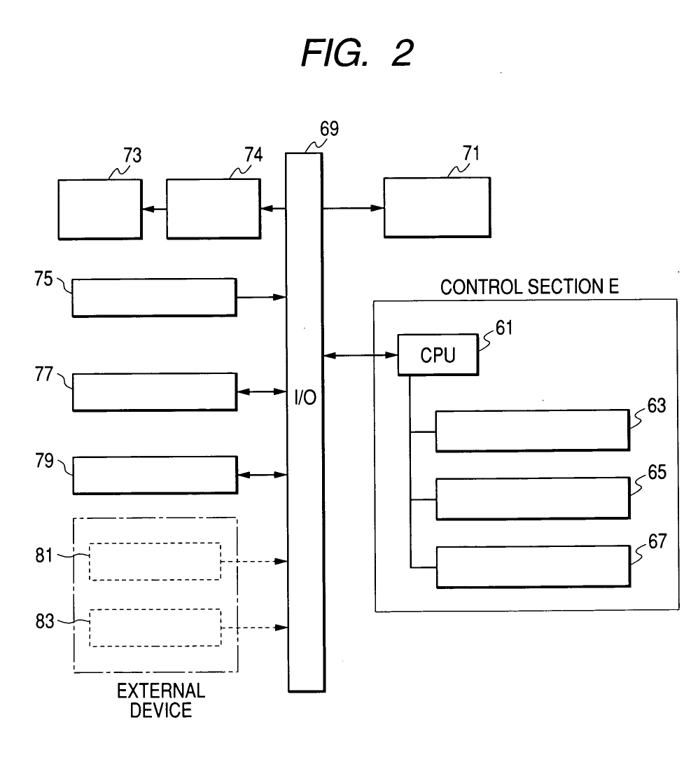

FIG. 1 is a block diagram for describing the schematic structure of a heat development recording apparatus of the invention, and FIG. 2 is a block diagram showing a control system of the heat development recording apparatus.

First, there will be described the configuration and operation of the heat development recording apparatus which carries out the image record processing method.

A heat development recording apparatus 100 shown in FIG. 1 uses a heat development recording material formed from a heat development photosensitive material or a photosensitive/heat-sensitive recording material, which do not require wet development processing. In accordance with an image signal input from an image information source, the light output from an image exposure section is subjected to scanning exposure while being modulated, to thus form a latent image on the heat development recording material. Subsequently, a visible image is obtained by subjecting the heat development recording material to heat 1 development, and the image is then cooled to room temperature.

Therefore, the heat development recording apparatus 100 has, in sequence in the direction in which the heat development recording material is transported, a heat development recording material supply section A, an image exposure section B, a heat development section C, and a cooling section D. The recorder 100 also has transport means which are disposed at principal sections between sections and transport the heat development recording material—and a power/control section E for driving and controlling the respective sections.

The heat development recorder 100 is configured such that the power/control section E is disposed at the bottom, such that the heat recording material supply section A is placed on top of the power/control section E, and such that the image exposure section B, the heat development section C, and the cooling section D are further laid on the heat recording material supply section A. The image exposure section B and the heat development section C are arranged adjacent to each other. Accordingly, processing pertaining to an exposure step and processing pertaining to a heat development step can be performed within a short transport range. A path over which the heat development recording material is to be transported can be minimized, thereby shortening a time required to output a sheet of heat development recording medium. One sheet of heat development recording medium can be simultaneously subjected to both processing pertaining to the exposure step and processing pertaining to the heat development step.

The previously-described heat development photosensitive material or the photosensitive/heat-sensitive recording material can be employed as the heat development recording material. The heat development photosensitive material is one which records an image through use of a light beam (e.g., a laser beam) (through exposure) and then causes the image to be colored by means of heat development. Further, the photosensitive/pressure-sensitive recording material is one which records an image by means of the light beam and causes the image to be colored through heat development or which causes an image to be colored concurrently with recording of the image in a heat mode (heat) of the laser beam and which then fixes the image through exposure.

The heat development recording material supply section A is a section which takes the heat development recording material one piece at a time and supplies the thus-taken material to an image exposure section B located downstream with respect to the direction in which the heat development recording material is to be transported. The heat development recording material supply section A comprises three loading sections 10a, 10b, and 10c; feed roller pairs 13a, 13b, and 13c arranged at the respective loading sections; an unillustrated transport roller; and an unillustrated transport guide. Magazines 15a, 15b, and 15c, which house different heat development recording materials (e.g., a B4-size or a half-cut size), are inserted into the respective loading sections 10a, 10b, and 10c configured in the form of three stages. Any of sizes and orientations of the recording materials loaded at the respective stages can be selectively used.

The heat development recording material is processed into the shape of a sheet. Normally, the heat development recording material is formed into a predetermined unit of (a bundle of) layered products; for example, 150 sheets, and packed as a package by means of a bag or band. The package is housed in the respective magazine and thus loaded in the respective stage.

The image exposure section B radiates a light beam LB onto the heat development recording material transported from the heat development recording material supply section A, by means of effecting scan exposure in the primary scanning direction. The image exposure section B also transports the heat development recording material in a secondary scanning direction (i.e., a transporting direction) substantially orthogonal to the primary scanning direction, whereby a desired image is recorded on the heat development recording material, to thus form a latent image.

The heat development section C subjects the heat development recording material that has undergone scan exposure to heating, to thus perform heat development. The cooling section D cools the heat development recording material that has undergone development and transports the thus-cooled recording material to an output tray 17.

Width alignment mechanisms 19 are provided along a transport path between the heat development recording material supply section A and the image exposure section B. The heat development recording material transported from the heat development recording material supply section A is supplied to the image exposure section B while widthwise edges of the material are aligned.

The image exposure section B will now be specifically described.

The image exposure section B is a section which exposes the heat development recording material through scan exposure of the light beam. The image exposure section B comprises a secondary scan transport section (secondary scanning means) 27 having a flap prevention mechanism, the mechanism transporting the heat development material while preventing flapping of the material from a transport surface; and a scan exposure section (laser exposure means) 29. The scan exposure section 29 effects scanning (primary scanning) through use of the laser beam while controlling an output of the laser beam in accordance with separately-prepared image data. At this time, the heat development recording material, denoted by reference numeral 21, is moved in the secondary scanning direction by means of the secondary scan transport section 27.

The secondary scan transport section 27 comprises two drive rollers 31, 33 whose axes are arranged substantially parallel to the primary scanning line of the radiated laser beam with the primary scanning line of the laser beam being sandwiched therebetween; and a guide plate 35 disposed opposite the drive rollers 31, 33 and supporting the heat development recording material 21. The guide plate 35 bends the heat development recording material 21 inserted between the drive rollers 31, 33 along a portion of a peripheral surface of one drive roller at a position outside the two side-by-side arranged drive rollers 31, 33, whereby the drive rollers 31, 33 receive elastic compressive force stemming from bending of the heat development recording material 21.

The bending incurs elastic compressive force in the heat development recording material. By means of the elastic compression force, predetermined frictional force develops between the heat development recording material 21 and the drive rollers 31, 33. Transport drive force is transmitted from the drive rollers 31, 33 to the heat development recording material 21 without fail. Accordingly, flapping of the heat development recording material 21 from the transport surface; that is, vertical flapping of the same, is prevented without fail. The laser light is radiated on the heat development recording material 21 located between the driver rollers, thereby enabling superior record processing without involvement of a displacement of exposure position. Here, the drive rollers 31, 33 receive the drive force of drive means, such as an unillustrated motor, by way of transmission means, such as a gear or a belt, to thus rotate in a clockwise direction in FIG. 1.

Next, the heat development section C will be described.

The heat development section C heats a heat development recording material of a type to be thermally processed. The heat development section C is configured by means of bending a plurality of plate heaters 37a, 37b, and 37c—which serve as heating elements to be heated to a temperature required to process the heat development recording material 21 and are arranged in the transporting direction of the heat development recording material—and arranging the plate heaters 37a, 37b, and 37c in a sequence of a circular arc.

The configuration of the heat development section C including the plate heaters 37a, 37b, and 37c is such that a recessed surface is formed in each of the plate heaters 37a, 37b, and 37c and such that heat development recording material 21 is moved relatively while being brought in slidable contact with the recessed surfaces of the plate heaters 37a, 37b, and 37c. A feed roller 39 and a plurality of press rollers 41 to be used for transmitting heat from the respective plate heaters to the heat development recording material 21 are arranged as means for transporting the heat development recording material 21.

The press rollers 41 are rotationally driven so as to follow rotation of a gear 43 while meshing with the gear 43. Metal rollers, resin rollers, or rubber rollers can be utilized as the press rollers 41. By means of this configuration, the heat development recording material 21 is transported while being pressed against the plate heaters 37a, 37b, and 37b, thereby preventing buckling of the heat development recording material 21. The curved plate heaters are examples, and there may also be adopted a configuration in which flat plate hears or heating drums are used as the heating means.

An output roller 45 for moving the heat development recording material is disposed at the end of the transport path of the heat development recording material 21 within the heat development section C. The heat development recording material 21 transported from the heat development section C is cooled while attention is paid so as to prevent occurrence of wrinkles, which would otherwise be caused by the cooling section D, and imparting of a curving nature. The heat development recording material 21 output from the cooling section D is guided through the inside of a guide plate 49 by means of cooling roller pairs 47 disposed at arbitrary points along the transport path and further output to the output tray 17 from a pair of output rollers 51.

The plurality of cooling roller pairs 47 are disposed within the cooling section D so as to impart a desired constant radius of curvature R to the transport path of the heat development recording material 21. This means that the heat development recording material 21 is transported at a given radius of curvature R until it is cooled to a glass transition point of the heat development recording material 21 or a lower temperature. As s result of the radius of curvature being intentionally imparted to the heat development recording material, the heat development recording material is prevented from acquiring additional curl before being cooled to the glass transition point. If the heat development recording material is cooled to the glass transition point or a lower temperature, acquisition of a new curl is prevented, thereby hindering occurrence of variations in the extent of curl.

The cooling rollers 47 and the internal ambient temperature of the cooling section D are controlled. By means of such a temperature control operation, the status of a heat treatment device is made as analogous as possible to that achieved after the device has been sufficiently run, to thus reduce variations in density.

Details of recording of an image on the heat development recording material 21 are described in, e.g., official gazettes International Publication Nos. WO95/31754 and WO95/30934, and the reader is invited to refer to the gazettes, as required.

As shown in FIG. 2, the control section E has a CPU 61. The CPU 61 is connected to at least a record processing program storage section 63, an operation explanatory image storage section 65, and a temporary storage section 67. The record processing program storage section 63 stores processing programs corresponding to respective record processing methods, such as a change in the recording priority of unprocessed record jobs and deletion of record jobs.

The operation explanatory image storage section 65 stores a plurality of operation explanatory images to be displayed on the display section 73. The temporary storage section 67 is a storage area which is temporarily created during the course of record processing of the heat development recording apparatus 100, and all record jobs for record processing and states thereof are stored in the temporary storage section 67. The image information itself is large in volume and, hence, stored in an image storage section 77 which will be described later, and after finished undergoing recording and output the record job is automatically deleted.

The control section E is connected to individual sections in the apparatus and external devices by way of an interface (I/O) 69. Specifically, the interface 69 is connected to a drive section 71, and the drive section 71 actuates individual mechanism portions of the heat development recording apparatus 100.

In addition to the elements set forth, the interface 69 is connected to a display section 73, an operation input section 75, an image processing section 79, an image storage section 77, an image information source 81, and an image server 83.

The display section 73 displays an executing state of the record job and an image for explaining an operation or an operation explanatory image or requirements to record data on the heat development recording material 21 or to thermally develop the heat development recording material 21 and is activated by a display driver 74. For instance, a liquid-crystal display panel or the like is used for the display section 73.

The operation input section 75 performs input of various input items, such as details on control operation, and enables setting of requirements for subjecting the heat development recording medium 21 to recording and heat development operations and input of a various operation instruction concerning record processing. In the embodiment, the operation input section 75 is of a touch-panel type and comprises a plurality of transparent input switches provided in a specific display area of the display section 73 in an overlapping manner.

The image storage section 77 stores image information transmitted from the image information source 81 of the external device, and the image processing section 79 processes the image information of the image storage section 77 and the image information input from the image information source 81 into recordable image data conforming to predetermined standards.

The present embodiment describes a case where the image processing section is provided on the heat development recording apparatus 100, but the image processing section 79 may be provided on the image information source 81 or at any position along the connection between the heat development recording apparatus and the external device. Further, the image storage section 77 may be provided with the external image server 83 or the like.

During the course of execution of the record processing formed from the exposure operation and the heat development operation, the control section E receives an operation instruction from the operation input section 75, thereby carrying out the operation instruction, such as an operation instruction to cause the display section 73 to display an image of an executing state of a record job and an image for explaining an operation. In accordance with the operation instruction input from the operation input section 75 according to the operation explanatory image, the control section E can freely change details on execution of a record job. Specifically, performance of the operation instruction is made possible along with the record processing.

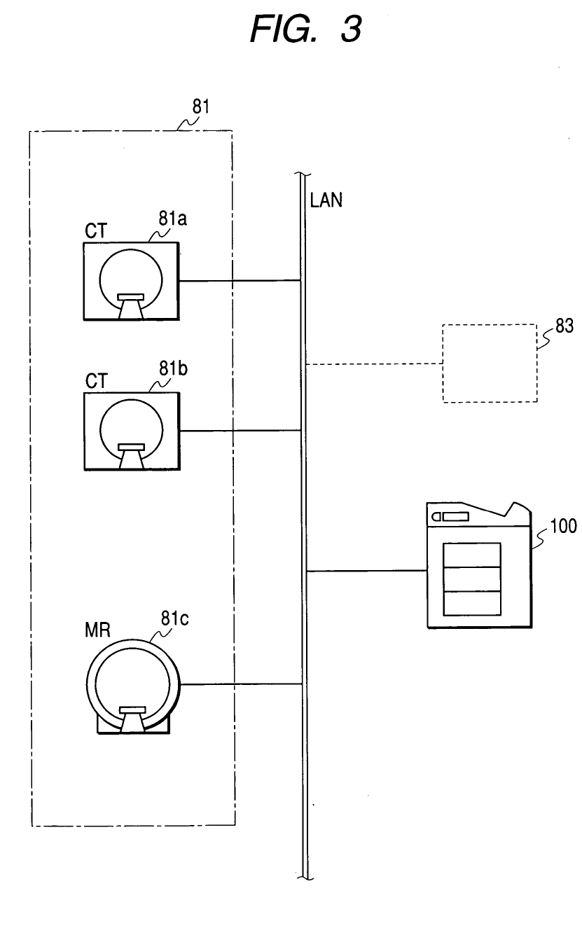

FIG. 3 is a block diagram showing an example system to which the heat development recording apparatus shown in FIG. 1 is connected.

As shown in FIG. 3, the heat development recording apparatus 100 having the foregoing configuration is built into a system, wherein pieces of various image information sources (modalities) 81, such as pieces of CT (computer tomography) apparatus 81a, 81b, and various image information sources such as an MRI (magnetic resonance imaging) system 81c or the like are connected to a LAN (Local Area Network). There may be a case where the system is provided with the image server 83. Specifically, the image information obtained from the image information source 81 is stored in the image storage section 77 shown in FIG. 2 or in the image storage section 77 after having been processed into a data format of specific standard by the image processing section 79.

The heat development recording apparatus 100 connected to the system stores, in the temporary storage section 67, various information pieces; for example, output statuses of images, such as the statuses of output requests received from the plurality of image information sources 81, the status of transfer of images from the image information sources, the status of image processing being performed by the image processing section 79, output statuses of images, or the like.

The image recording method performed by the heat development recording apparatus 100 will now be described in conjunction with a display screen.

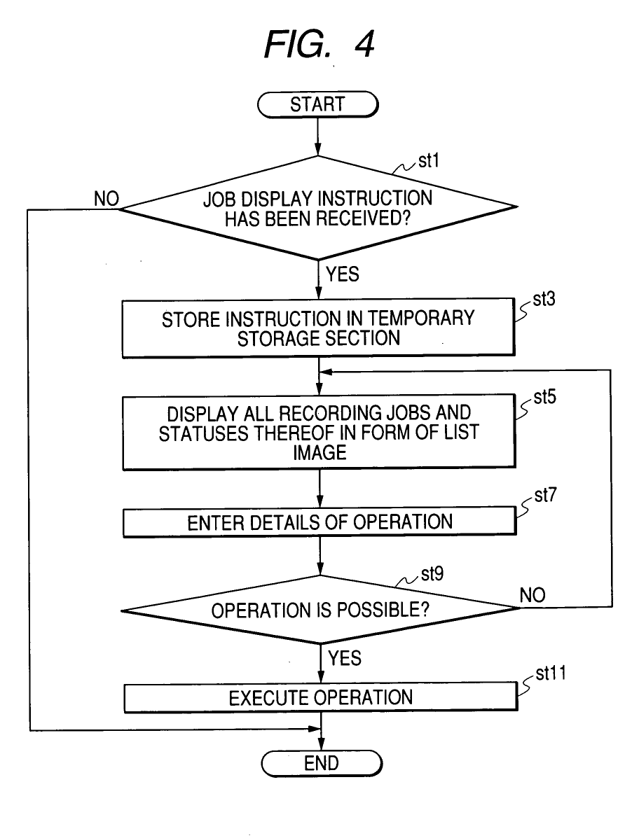

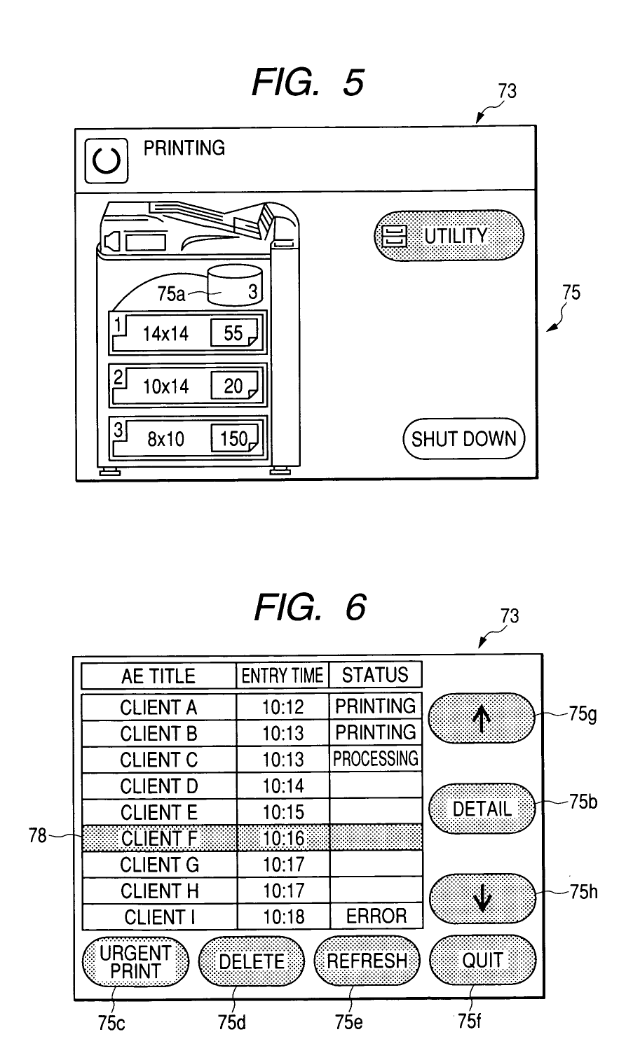

FIG. 4 shows a flowchart for describing procedures for displaying details on the display section and carrying out operation, and FIGS. 5 to 7 show details to be displayed on the display section of the heat development recording apparatus.

In the heat development recording apparatus 100, a screen display shown in FIG. 5 is displayed on the display section 73 during the course of record processing being performed. When an icon 75a assigned to a hard disk drive, which is one of the operation input sections 75 appearing on the touch-panel display section 73, is pressed (st1), a specific program stored in the record processing program storage section 63 is preserved in the temporary storage section 67, as are all the record jobs and the statuses thereof which have been achieved at this point in time (st3). All the record jobs stored in the temporary storage section 67 and details thereof are displayed in a queue list image shown in FIG. 6 on the display section 73 (st5).

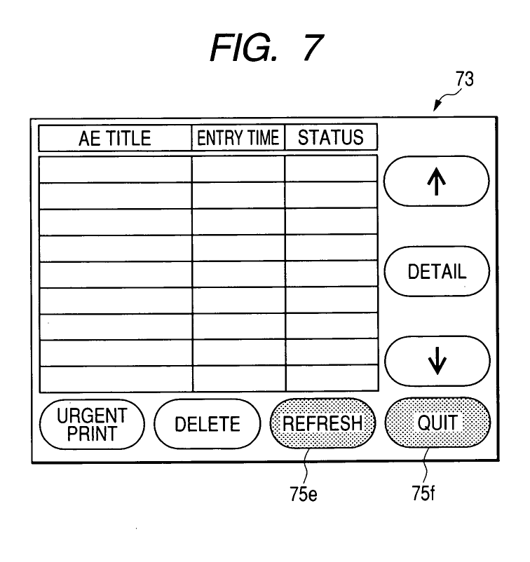

A detail display icon 75b, a urgent print icon 75c, a deletion icon 75d, an refreshing icon 75e, a terminate icon 75f, and a scroll icons 75g, 75h are displayed on the display section 73 on which the queue list image has been displayed. When the record job is not accumulated, a blank queue list image, such as that shown in FIG. 7, is displayed, and only the refreshing icon 75e and the termination icon 75f become operative.

When the operation input section 75 has been operated (st7), a determination is made as to whether or not the operation is possible (st9). Specifically, when the selected record job is a backlog job before recording, processing of operations, such as urgent print or deletion, are enabled, and operations for a record job whose output has already been initiated and a record job in progress are disabled. If the input processing is an operation which can be enabled, the processing is performed (st11). If processing is a disabled operation, a queue list image is again displayed.

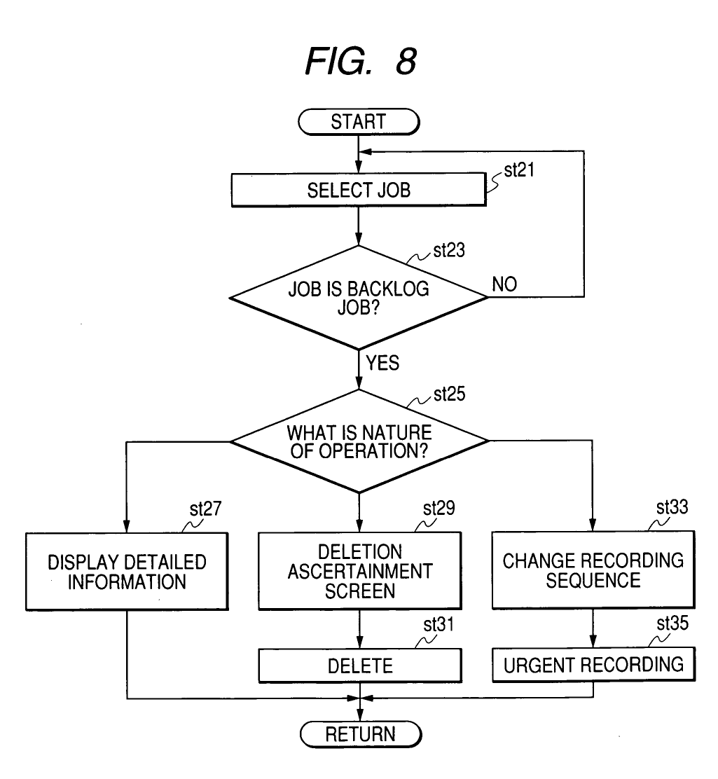

Details of the respective operations entered by way of the operation input section 75 will be described in more detail by reference to FIG. 8.

FIG. 8 is a flowchart for describing detailed procedures for performing operations.

(Display of Details)

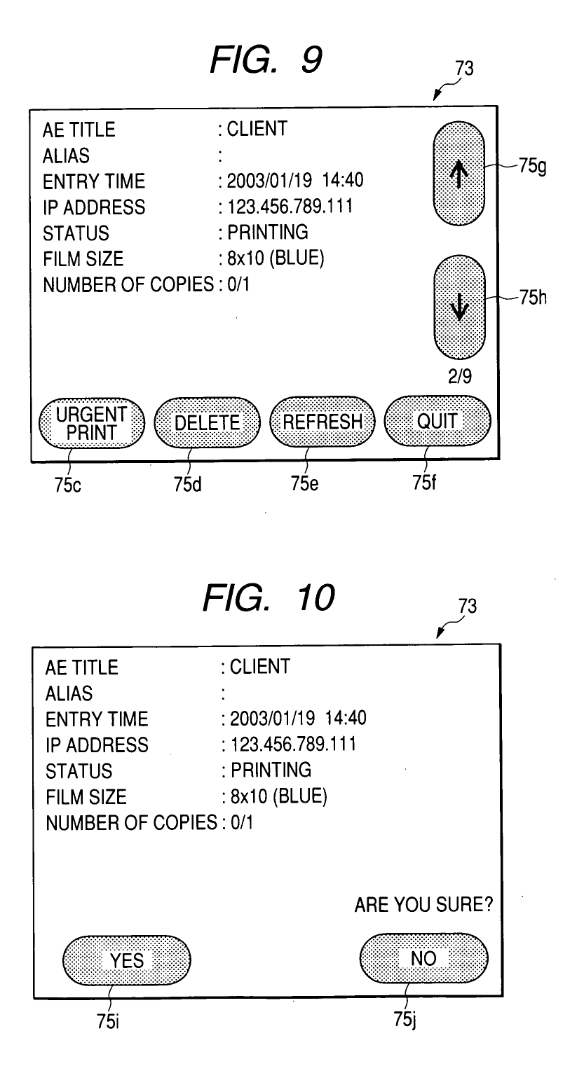

In relation to the queue list image shown in FIG. 6, the scroll icons 75g, 75h, for instance, are operated, whereby a specific record job 78 is selected as an object to be processed from the queue list image (st21). When the thus-selected record job 78 is a backlog job (st23) and when the detail display icon 75b, for instance, is pressed (st25), a detail display program of the record processing program storage section 63 is carried out. As shown in FIG. 9, detailed information about the selected job stored in the temporary storage section 67 is displayed on the display section 73 (st27). In contrast, when the selected record job 78 is not a backlog job, the queue list image still remains displayed. Further, when the selected job is not a backlog job, a message indicating that details of the selected job cannot be displayed may be displayed on the display section 73, to thus inform the operator of the occurrence of erroneous input. Moreover, details of the job that is undergoing image processing or being output can be displayed.

For instance, an AE title [an application identifier (conforming to DICOM standards) of the image information source], an alias which can be set arbitrarily, a date on which an output request is received, an identifier of the image information source (an IP address on the network or the like), the status of a record job, a film size, the number of copies, and the like are displayed as detailed information about the selected job. When an operation for displaying a list of record jobs is instructed at the time of display of the information items, all the record jobs and their statuses, which are obtained at that point in time, are stored in the temporary storage section 67. At a point in time when an operation instruction concerning display of detailed information is issued, detailed information about the record job is referred to by way of the temporary storage section 67 on the basis of an identification number assigned to the record job, and the thus-referred information is displayed.

(Deletion of Record Job)

The specific record job 78 is selected as an object to be processed from the queue list image shown in FIG. 6 (st21). When the selected job is a backlog job (st23) and the deletion icon 75d is pressed (st25), a deletion confirmation image shown in FIG. 10 is displayed (st29). As a result of a YES icon 75i being pressed, the selected job is deleted (st31). More specifically, when display of a list of record jobs is instructed through operation, all record jobs and statuses thereof, which are obtained at that point in time, are saved in the temporary storage section 67. When a deleting instruction has been issued, a determination is made as to whether or not the record job can be deleted, on the basis of the identification number of the record job. If deletion of the record job is possible, an operation for deleting the record job is performed. When deletion of the record job from the queue list image has been performed, the position of a cursor remains unchanged, but the record job information items subsequent to the cursor are each advanced by one position. Moreover, deleting operation can be performed analogously by pressing the detailed information deletion icon 75d.

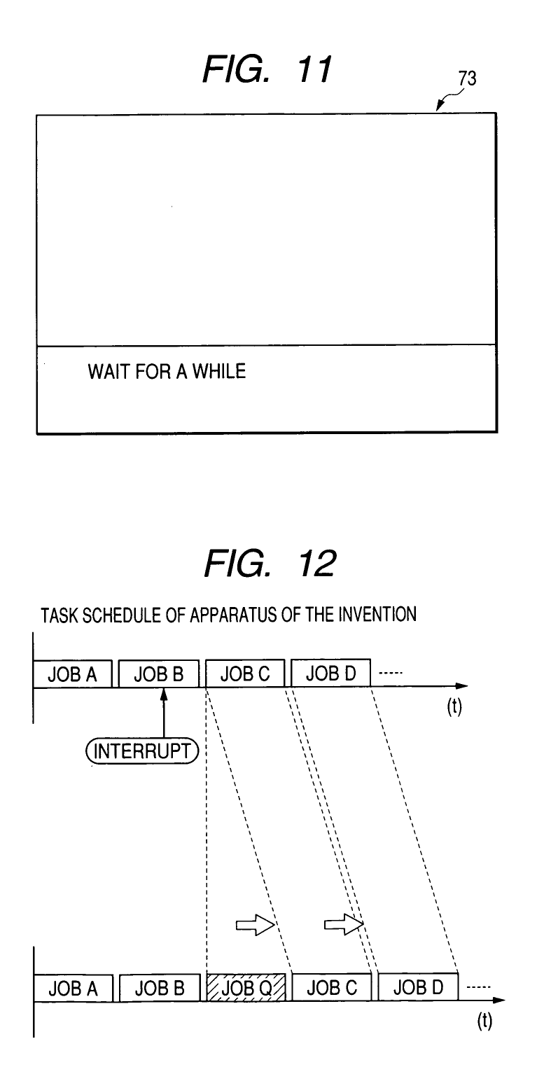

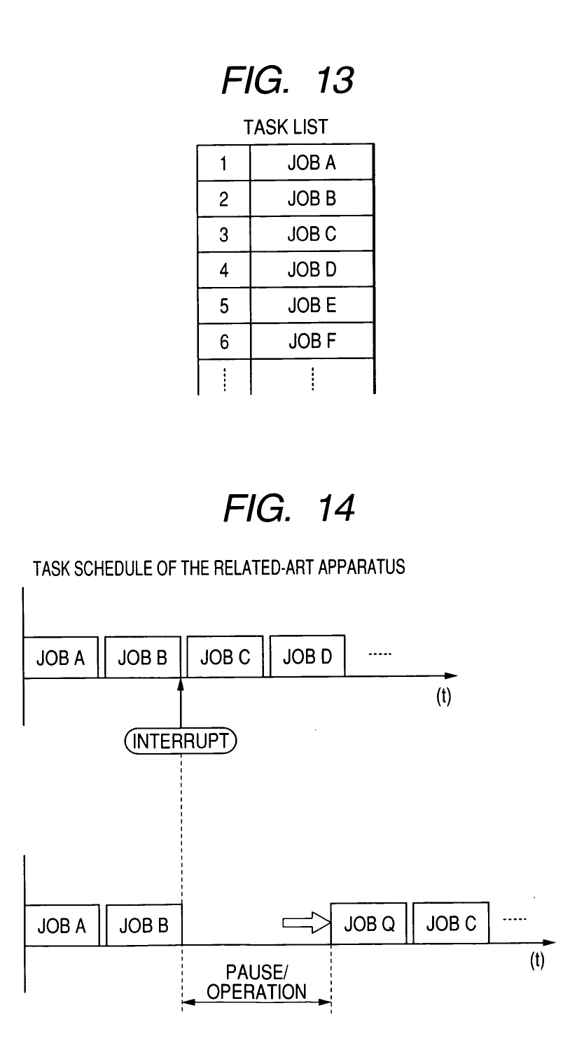

When the selected job is not a backlog job or when a NO icon 75j shown in FIG. 10 is pressed, processing returns to the original queue list image. Moreover, when the selected job is not a backlog job, a message indicating that deletion of the selected job is possible is displayed on the display section 73, thereby informing the operator of an erroneous input. During the deleting operation, the image which is in progress and shown in FIG. 11 is displayed on the display section 73, and useless input is not accepted.

(Urgent Print)

The specific record job 78 is selected as an object to be processed from the queue list image shown in FIG. 6 (st21). When the selected job is a backlog job (st23) and when the urgent print icon 75c is pressed (st25), the thus-selected job is recorded before any other backlog job. When the selected job is not a backlog job, the queue list image still remains.

Specifically, when display of the list of record jobs is instructed, all the record jobs and statuses thereof obtained at that point in time are stored in the temporary storage section 67. At a point in time when an instruction for urgent recording has been issued, a determination is made as to whether or not urgent recording of the record job is possible, on the basis of an identification number of the record job. If the urgent record processing is possible, a change in recording priority is stored in the temporary storage section 67 (st33).

As a result, prioritized recording of the record job Q is performed after completion of the currently-performed record job (st35). Urgent processing can be performed by means of depressing the detailed information urgent print icon 75c shown in FIG. 6. When urgent record processing is impossible, processing returns to the queue list image. In that case, a message indicating that urgent recording of the selected job is impossible is displayed on the display section 73, and the operator may be informed of an erroneous input. During the course of record processing being performed through urgent processing, an processing-in-process image shown in FIG. 11 is displayed on the display section 73, whereby a useless input cannot be input.

At the time of completion of the urgent record processing, sorting operation is again performed in accordance with a predetermined sorting requirement. In the queue list image displayed immediately after completion of urgent record processing, a cursor of the queue list image is displayed at the position of the record job that has been subjected to urgent recording. At the time of display of detailed information, details of the record job are displayed. As a result, the operator can be definitely informed that the recorded and output image is a urgent output image while the recorded image is displayed so as to be distinguished from other record jobs.

According to the urgent record processing, when recording request is issued in sequence of the record jobs A, B, C, and D as indicated by an example task schedule shown in, e.g., FIG. 12, and when the urgent print icon 75c is pressed during the course of recording of the record job B (or during the course of image processing), the next record job C subsequent to the record job which is in progress is pushed back in order to induce an interrupt of the urgent record job Q. Accordingly, the urgent record job Q is introduced and subjected to recording between a timing at which the urgent print icon 75c is pressed and a timing at which the next record processing is introduced. In association with this interrupt processing, the record job C, which is the next job in the original recording sequence, and the record job D, which immediately follows the record job C, are pushed back to a position subsequent to the record job Q, whereby record processing is performed.

(Refreshing Record Job)

When the refresh icon 75e is pressed while the queue list image shown in FIG. 6 is being displayed or when the detailed information shown in FIG. 9 is displayed, the queue list image or the detailed information is refreshed to details of the latest record job. Specifically, at a point in time when the refresh icon 75e is pressed, all the record jobs and statuses thereof are written over and stored in the temporary storage section 67, to thus refresh the queue list image or the detailed information, and the thus-stored data are displayed as a queue list image or detailed information. Accordingly, the statuses of all the record jobs obtained at an arbitrary point in time when the operation instruction has been issued can be grasped accurately.

Refreshing operation may be automatically performed at a given interval. In this case, all the record jobs and statuses thereof are written over the temporary storage section 67 at given time intervals, to thus automatically refresh the queue list image or the detailed information, and the thus-stored data are displayed as the queue list image or the detailed information at given time intervals. As a result, the latest image can be obtained at all times at given intervals without input of the operation instruction byway of the operation input section 75.

Preferably, when automatic refreshing operation is performed, an refreshing time can be set arbitrarily. In this case, when the automatic refreshing time is input from the operation input section 75 by means of an operation, the queue list image is automatically refreshed at every preset timing. As a result, the time at which automatic refreshing operation is performed can be set arbitrarily, and an optimum refreshing period can be set in accordance with frequency of processing of the record job.

As mentioned above, the heat development recording apparatus 100 can receive the operation instruction input way of the operation input section 75 even during the course of record processing, to thereby enable ascertainment of the status of execution of the record job and a modification in the details of the record job that are now being carried out. Further, operations per se are simplified by means of display of operation descriptions. Further, as a result of the operation instruction being input from the operation input section 75 in accordance with the operation descriptions, the heat development recording apparatus 100 can process the record job of image information desired to be processed urgently with high priority or delete a record job of undesired image information even during the course of record processing being performed. Flexible recording of an accumulated backlog of jobs can be performed readily within a short period of time and without involving complicated operations, such as issuance of an operation instruction to a server or the like of the network connected to the heat development recording apparatus 100.

In accordance with the operation instruction input from the operation input section 75, the job in progress and a backlog of jobs are displayed as a queue list image on the display section 73. Hence, the status of a backlog of jobs, which cannot be ascertained unless the record processing is temporarily stopped (e.g., a determination as to whether or not the job is currently being processed or how many jobs remain before record processing is performed, or the like), can be ascertained while record processing is continued. Thus, the heat development recording apparatus can ascertain the status of an accumulated backlog of jobs while continuing the record processing, thereby enabling smooth medical practice.

As has been described in detail, according to the image record processing method of the invention, an operation instruction entered from the operation input section is accepted during the course of record processing being performed, and processing corresponding to the operation instruction can be performed simultaneously with the record processing. Specifically, when the operation instruction entered by way of the operation input section is accepted, processing pertaining to the operation instruction can be performed simultaneously with record processing even when the record processing is in progress. As a result, an operation instruction can be input from the operation input section at an arbitrary timing without the operator being aware of whether or not the record processing is in progress.

The heat development recording apparatus of the invention comprises a display section for displaying the status of a record job, the operation input section for inputting an operation instruction pertaining to the record job, and the control section for controlling heat development record processing on the basis of the image record processing method. Even if record processing of the heat development recording apparatus is in progress when an operation instruction pertaining to a specific record job has been received from the operation input section in relation to the record jobs displayed on the display section, processing of the operation instruction can be carried out simultaneously with the record processing. As a result, flexible record processing, such as display of or modification to accumulated jobs, can be implemented while the record processing is being carried out.

What is claimed is:

1. An image record processing method comprising:
(1) generating a plurality of record jobs corresponding to a plurality of image information data transmitted from at least one of an image information source;
(2) performing record processing to achieve heat development; the processing including:
(2-1) performing one of the record jobs with a heat development recording apparatus, to thus form a latent image through exposure of a heat development recording material; and
(2-2) heating the heat development recording material having the latent image formed thereon, and
(3) sequentially performing the record processing with respect to each of the remaining record jobs,
wherein, when the heat development recording apparatus receives a predetermined operation instruction from an operation input section while the record processing is being performed, at least a part of the processing of the operation instruction is performed simultaneously with at least a part of the record processing.

2. The image record processing method according to claim 1, further comprising:
displaying a queue list image of the record jobs on a display section of the heat development recording apparatus when the heat development recorder receives a predetermined operation instruction from the operation input section.

3. The image record processing method according to claim 1, further comprising:
selecting a specific record job as an object job to be processed when the heat development recording apparatus receives a predetermined operation instruction from the operation input section; and
performing the object job with higher priority over other record jobs to effect recording, according to a predetermined operation instruction from the operation input section, if the selected job is in an unprocessed status.

4. The image record processing method according to claim 1, further comprising:
selecting a specific record job as an object job to be processed when the heat development recording apparatus receives a predetermined operation instruction from the operation input section; and
deleting the object job according to a predetermined operation instruction from the operation input section, if the selected job is in an unprocessed status.

5. The image record processing method according to claim 1, further comprising:
selecting a specific record job as an object job to be processed when the heat development recording apparatus receives a predetermined operation instruction from the operation input section; and
displaying detailed information about the object job, according to a predetermined operation instruction from the operation input section.

6. The image record processing method according to claim 2, further comprising:
refreshing the queue list image to the latest image of record jobs at a predetermined timing.

7 The image record processing method according to claim 6, wherein the queue list image is automatically refreshed at every predetermined period.

8. The image record processing method according to claim 6, wherein the queue list image is automatically refreshed at every period instructed by operation performed by the operation input section.

9. A heat development recording apparatus used in a heat development record operation for (1) performing record processing to achieve heat development, the processing including: (1-1) performing one of a plurality of record jobs through use of the recorder, the record jobs being generated in accordance with a plurality of image information data transmitted from at least one of an image information source, to thus form a latent image through exposure of a heat development recording material; and (1-2) heating the heat development recording material having the latent image formed thereon, and (2) sequentially performing the record processing with respect to each of the remaining record jobs, the recording apparatus comprising:
a display section for displaying the status of at least one of the record jobs;
an operation input section where an operation instruction pertaining to each of the record jobs is input; and
a control section for controlling the heat development record processing, wherein, when the heat development recording apparatus receives a predetermined operation instruction from the operation input section while the record processing is being performed, at least a part of the processing of the operation instruction is performed simultaneously with at least a part of the record processing.
